(19) United States
(12) Patent Application Publication
(10) Pub. No.: US 2006/0053915 A1
(43) Pub. Date: Mar. 16, 2006

(54) Steering system

(75) Inventor: Jochen Horwath, Unterensingen (DE)

Correspondence Address: ROBERT W. BECKER & ASSOCIATES, 707 HIGHWAY 66 EAST, SUITE B, TIJERAS, NM, 87059, US

(73) Assignee: ThyssenKrupp Presta SteerTec GmbH, Dusseldorf (DE)

(21) Appl. No.: 10/544,568

(22) PCT Filed: Oct. 13, 2003
(86) PCT No.: PCT/EP03/11305

§ 371 Date: Aug. 3, 2005

(30) Foreign Application Priority Data
Feb. 4, 2003 (DE) 103 04 520.1

(51) Int. Cl. F16H 35/00

(52) U.S. Cl. 74/388 PS

(57) ABSTRACT

A steering system for a motor vehicle, comprising a shaft that is rotatably mounted on the chassis of the vehicle, a carriage that is connected to the shaft via a threaded mechanism so as to be displaceable along the shaft, two tie rods secured to the carriage and extending to wheels of an axle of the vehicle, and a bar that is secured to the chassis of the vehicle and extends parallel to the shaft, wherein the bar extends through the carriage, which is displaceable along the bar.

The present invention relates to a steering system for a motor vehicle, in particular for a commercial vehicle.

German patent document available for public inspection 22 14 577 (DT 22 14 577 B2) discloses a rack and pinion steering system for vehicles, whereby a rack extends through a pinion housing, in which a pinion connected to the steering wheel that engages with the teeth of the rack is arranged. Turning the steering wheel causes a linear movement of the rack, at both ends of which tie rods are fixed by means of axial ball joints.

With front axle loads of more than 4 tons, especially in the field of commercial vehicles, the statutory regulations (EEC 70/311 and 38 StVZO) impose a very high transmission ratio for the steering gear consisting of rack and pinion, whereby it is necessary to make the pinion so small that its mechanical durability can no longer be assured.

Based on this prior art the object of the invention is to provide a steering system for a motor vehicle, in particular for a commercial vehicle, in the case of which a high transmission ratio can be realized and at the same time a high degree of mechanical durability. This object is achieved according to the invention with a steering system for a motor vehicle, in particular for a commercial vehicle, with the features according to claim 1. Preferred further developments are described in the sub-claims.

The inventive steering system and/or the axle positioner according to the invention comprises a shaft that is rotatably mounted on the vehicle chassis, a carriage that is connected to the shaft and that can be displaced along the latter and two tie rods that are fixed to the carriage and extend up to the two wheels of an axle, the carriage being connected to the shaft by means of a threaded mechanism.

Since a threaded mechanism is used in place of a linear mechanism consisting of rack and pinion, a very high transmission ratio and at the same time greater effective contact and/or adhesion surface for transmitting the forces and/or the movements in the steering gear is possible. Thus however the surface pressure arising on the contact surfaces can be reduced in the case of a threaded mechanism compared to a rack, which leads to increased mechanical durability of the threaded mechanism.

The threaded mechanism can be constituted as a spindle drive, whereby a thread formed on the outer periphery of the shaft engages with a thread formed in a bore of the carriage. Preferably however the threaded mechanism is formed as a ball screw and/or re-circulating ball screw, whereby balls arranged in the bore of the carriage engage in a spiral groove formed on the periphery of the shaft. The friction arising in the threaded mechanism can be substantially reduced by such an arrangement.

In motor vehicles a steering shaft connected to the steering wheel is not normally arranged in parallel but especially perpendicular to the wheel axle. The rotatably mounted shaft in accordance with the invention however advantageously runs parallel with this axle, so that the steering shaft is connected to the shaft that is rotatably mounted on the vehicle chassis preferably via a reversing gear. Since the transmission ratio of the steering system can be adjusted in wide ranges, for example by means of the upward gradient of the thread formed on the shaft and/or the spiral groove formed on the shaft, the reversing gear preferably has a transmission ratio of 1. Of course it is also possible to design the reversing gear with a transmission ratio that is not equal to 1 if this appears desirable due to special demands on the motor vehicle.

The tie rods can be fixed at the ends of the carriage facing the wheels. Preferably however the tie rods are centrically fixed to the carriage, so that a long tie rod length can be achieved, which is advantageous from a vehicle-kinematic aspect. The expression “centrically” here relates to the longitudinal extension in the displacement direction of the carriage.

In order to make the inventive steering system easier to handle, it can be equipped with hydraulic power assistance, which intensifies the force applied by the driver to steer the wheels. The hydraulic power assistance in this case can be implemented by means of a valve assembly, which is normal in power steering systems and can be arranged at any point in the transmission path for the steering movements.

The carriage is preferably connected to a bar parallel with the shaft and fixed to the vehicle chassis, along which bar the carriage can be displaced. As a result the stability of the inventive steering system can be further increased, since dual guidance for the carriage is achieved by means of the shaft and the bar.

A cylinder, which sits in a cylinder bore formed in the carriage and closed on both end faces, can be formed on the bar. The cylinder, which has a diameter larger than the bar, with the two end faces in each case thereby encloses an area which can be used as hydraulic working space for the hydraulic power assistance. For this purpose only inlet pipes to the working spaces, through which hydraulic fluid can be brought into the working spaces or removed from the later as a function of a steering movement, are necessary. The inlet pipes can be provided in the carriage. Preferably however the inlet pipes are formed in the bar, since this is arranged immovably on the vehicle chassis and thus no hydraulic line has to be led across a moving part and/or to a moving part. In accordance with this development the cylinder cannot move relative to the vehicle chassis, whereby the working spaces can be reduced or increased by moving the carriage.

The operating mode of the inventive steering system is such that a rotating movement, transmitted to the shaft that is rotatably mounted on the vehicle chassis, is converted with a transfer factor into a linear movement of the carriage, which controls the steering angle of the wheels by means of the tie rods.

The invention is described below on the basis of a preferred embodiment with reference to the drawing, wherein:

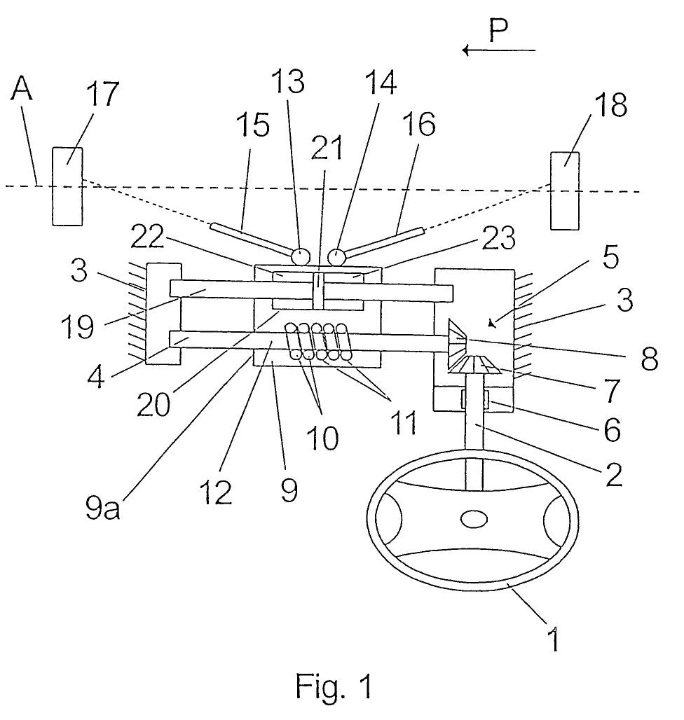

FIG. 1 is a schematic view of an embodiment of the inventive steering system for a motor vehicle,

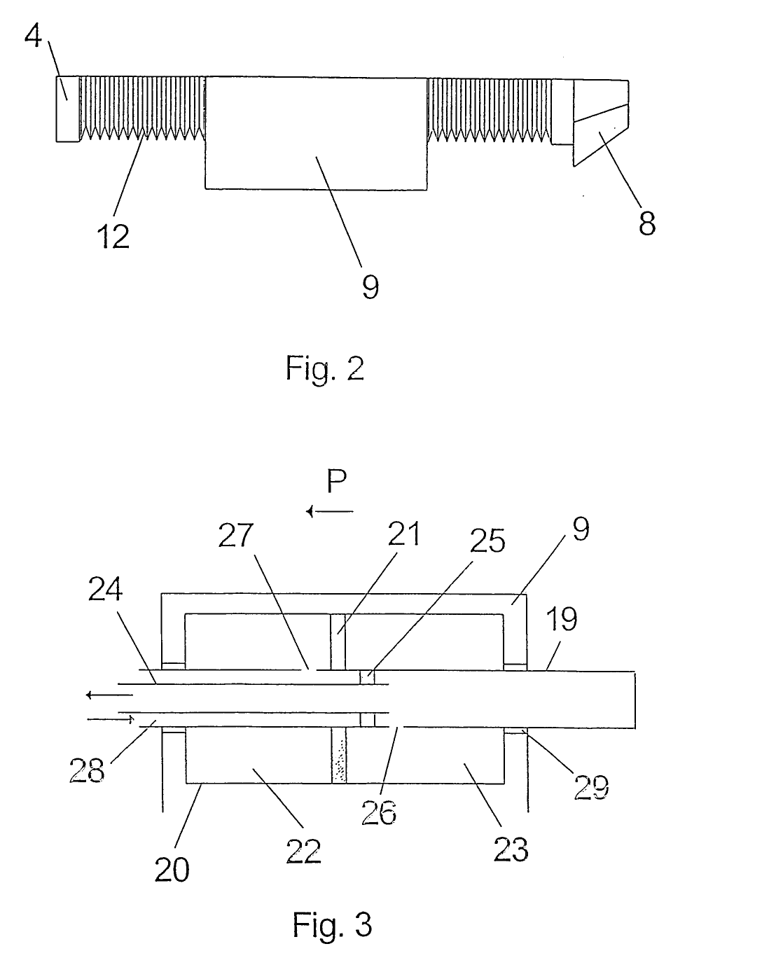

FIG. 2 is an enlarged partial illustration of the shaft that is rotatably mounted on the vehicle chassis, and

FIG. 3 is a schematic illustration of the hydraulic power assistance.

FIG. 1 shows a steering wheel 1, which is connected by means of a steering shaft 2 via a reversing gear 5 to a shaft 4 that is rotatably mounted on the vehicle chassis 3. The steering shaft 2 is rotatably mounted on the vehicle chassis 3 by means of a bearing 6 and at its end facing away from the steering wheel 1 has a conical gear wheel 7, which engages a conical gear wheel 8 arranged at one end of the shaft 4. The gear wheels 7 and 8 forming the reversing gear 5 are designed so that the reversing gear has a transmission ratio of 1.

The shaft 4 aligned perpendicularly to the steering shaft 2 extends through a bore 9a formed in a carriage 9, in which several balls 10 are rotatably arranged. The balls 10 sit in recesses 11 formed in the carriage 9 and engage in a spiral groove 12 formed on the surface of the shaft 4 (see FIG. 2). The shaft 4 with the spiral groove 12 together with the balls 10 and the carriage 9 form a threaded mechanism, which converts a rotation of the shaft 4 into a linear movement of the carriage 9. Since the shaft 4 is connected to the steering wheel 1 via the reversing gear 5 and the steering shaft 2, the rotating movement of the steering wheel is also converted into a linear movement of the carriage 9.

Two tie rods 15 and 16 are centrically fixed to the carriage 9 by means of ball joints 13 and 14, and extend up to the two wheels 17 and 18 of a wheel axle A. By means of this connection—illustrated by dashes—of the tie rods 15 and 16 with the wheels 17 and 18 their steering angle can be adjusted and/or changed by a turn of the steering wheel 1.

In addition the carriage 9 is passed through by a bar 19 aligned in parallel with the shaft 4 and fixed to the vehicle chassis 3, which bar, in a bore 20 formed in the carriage 9, has a piston 21 with a diameter larger than the bar 19. The piston 21 lies sealingly against the wall of the bore 20 and with the end faces of the bore 20 encloses two working chambers 22 and 23. Furthermore the bar 19, which extends through the end faces of the bore 20, is sealingly mounted therein. Hydraulic fluid can be brought into each of the working chambers and/or working spaces 22, 23, or discharged from each of the working spaces 22, 23, through inlet lines formed in the bar 19.

If the carriage 9 is to be displaced in the direction of the arrow P, the working chamber 22 is filled with the hydraulic fluid, whereas the hydraulic fluid can escape from the working chamber 23. Due to the pressure differential existing between the chambers 22 and 23 a force acts on the carriage 9 in the direction of the arrow P, which assists in displacing the carriage 9 in the direction of the arrow P caused by the driver turning the steering wheel 1. Now if the carriage 9 is to be displaced in the opposite direction to the arrow P, then the working chamber 23 is filled with hydraulic fluid, whereas the hydraulic fluid can escape from the working chamber 22. The piston 21 with this embodiment is static, so that a pressure differential existing between the chambers 20, 21 can only be effective in assisting displacement of the carriage 9.

FIG. 2 shows a side view of the shaft 4, which is illustrated only to half-way up its longitudinal axis. The thread and/or the spiral groove 12, in which the balls 10 shown in FIG. 1 engage, is clearly recognizable. In this case the transmission ratio of the threaded mechanism can be adjusted by means of the pitch of the thread 12.

A schematic illustration of the hydraulic power assistance in accordance with the embodiment is clear from FIG. 3. A pipe 24, which only extends over part of the length of the bar 19 and is fluid-sealed against the latter by means of a gasket 25, is concentrically arranged in the hollow bar 19 which is closed at one end. On both sides of the piston 21 in each case a hole 26, 27 is provided in the bar 19, whereby the hole 26 forms a passage to the working chamber 23 and the hole 27 forms a passage to the working chamber 22. The gasket 25 is arranged between these two holes 26, 27 so that hydraulic fluid can be brought through the pipe 24 into the working chamber 23, and through the annular gap 28 formed between the pipe 24 and the bar 19 into the working chamber 22. If the carriage 9 is to be displaced in the direction of the arrow P for example, hydraulic fluid is supplied through the annular gap 28 to the chamber 22, whereas hydraulic fluid is discharged through the pipe 24 from the chamber 23. If the carriage 9 however is to be displaced in the opposite direction, hydraulic fluid is supplied through the pipe 24 to the chamber 23, whereas hydraulic fluid is discharged through the annular gap 28 from the chamber 22. The carriage 9 in this case is fluid-sealed against the bar 19 with gaskets 29.

### REFERENCE SYMBOL LIST

1 steering wheel
2 steering shaft
3 vehicle chassis
4 shaft
5 reversing gear
6 bearing
7, 8 conical gear wheels
9 carriage
9a bore
10 balls
11 recesses
12 spiral groove
13, 14 ball joint
15,16 tie rod
17,18 wheels
19 bar
20 bore
21 piston
22, 23 working chambers
24 pipe
25, 29 gasket
27 holes
28 annular gap
A wheel axle
P arrow

1-9. (canceled)

10. A steering system for a motor vehicle, comprising:
a shaft that is rotatably mounted on a chassis of said vehicle;
a carriage that is connected to said shaft via a threaded mechanism so as to be displaceable along said shaft;
two tie rods secured to said carriage 9 and extending to wheels of an axle of said vehicle; and
a bar that is secured to said chassis of said vehicle and extends parallel to said shaft, wherein said bar extends through said carriage, and wherein said carriage is displaceable along said bar.

11. A steering system according to claim 10, wherein said threaded mechanism is a ball screw mechanism.

12. A steering system according to claim 10, wherein a steering shaft is provided, and wherein said shaft 4 is connected with said steering shaft via a reversing gear.

13. A steering system according to claim 10, wherein said tie rods are centrically secured to said carriage.

14. A steering system according to claim 10 that is provided with hydraulic power assistance.

15. A steering system according to claim 14, wherein a bore is provided in said carriage, wherein end faces of said bore are closed off, and wherein a piston is formed on said bar and is disposed in said bore.

16. A steering system according to claim 15, wherein respective chambers are formed between said piston and said end faces of said bore, and wherein said chambers are fillable with hydraulic fluid via feed lines.

17. A steering system according claim 16, wherein said feed lines are formed in said bar.
